(19) United States
(12) Patent Application Publication
(10) Pub. No.: US 2023/0179676 A1
(43) Pub. Date: Jun. 8, 2023

(54) METHOD AND SYSTEM FOR ACTIONABLE PUSH NOTIFICATIONS

(71) Applicant: Shopify Inc., Ottawa (CA)

(72) Inventors: William Devine, San Francisco, CA (US); Ellen Dunne, San Francisco, CA (US); François Ok, Montreal (CA)

(21) Appl. No.: 17/837,804

(22) Filed: Jun. 10, 2022

Related U.S. Application Data
(60) Provisional application No. 63/285,763, filed on Dec. 3, 2021.

(51) Int. Cl. H04L 67/55; H04W 4/24; H04L 67/61

(52) U.S. Cl. CPC H04L 67/55; H04L 67/61; H04W 4/24

(57) ABSTRACT

A computer-implemented method for generating secondary notifications, the method including receiving a message; generating a primary notification of the message; updating a priority associated with the message; determining that the updated priority exceeds a threshold; and responsive to determining that the updated priority exceeds a threshold, generating a secondary notification, the secondary notification being distinct from the primary notification.

### CROSS-REFERENCE TO RELATED APPLICATIONS

The present application claims the benefit of priority to U.S. Pat. Application No. 63/285,763 entitled “METHOD AND SYSTEM FOR ACTIONABLE MERCHANT PUSH NOTIFICATIONS”, filed Dec. 3, 2021, the contents of which are herein incorporated by reference in their entirety.

### FIELD OF THE DISCLOSURE

The present disclosure relates to electronic messaging, and in particular relates to electronic messaging for electronic commerce transactions.

### BACKGROUND

Electronic messaging, such as email, text messaging and messaging through particular applications have become ubiquitous not only for personal communication, but also for business communication. For example, communication between buyers, sellers, distributors, providers and manufacturers of products and services now commonly takes place using various forms of electronic communication.

### SUMMARY

The ease at which sellers and customers can communicate electronically has led to the volume of such communications becoming potentially significant.

Specifically, a merchant can be overwhelmed by messages relating to an online store. However, not every message calls for urgent action. On the other hand, a message from a prospective customer — especially one that would be easy to answer —might warrant urgent action.

In this regard, manners of better message management is needed.

Such better message management may be provided according to the subject matter of the present application.

In one aspect, a computer-implemented method for generating secondary notifications is provided. The method may include receiving a message and generating a primary notification of the message. The method may further include updating a priority associated with the message and determining that the updated priority exceeds a threshold. The method may further include, responsive to determining that the updated priority exceeds a threshold, generating a secondary notification, the secondary notification being distinct from the primary notification.

In some embodiments the message may relate to at least one user accessing an e-commerce store, and wherein the priority may be updated based on the at least one user currently having an online session with the e-commerce store and having one or more items in a shopping cart associated with the online session.

In some embodiments, the method may include receiving one or more further messages at the computing device; and updating the priority associated with the message based on at least some of the one or more further messages.

In some embodiments, the updating the priority associated with the message may include analyzing the message to determine that the message relates to a pending or intended transaction rather than a completed transaction; and responsive to the determination that the message is related to a pending or intended transaction rather than a completed transaction, assigning a higher priority to the message.

In some embodiments, the updating the priority associated with the message may include: analyzing the message to determine that a response to the message will take less than a threshold time period; and responsive to the determination that the message will take less than a threshold, assigning a higher priority to the message.

In some embodiments, the updating the priority may be based on at least one of: a customer profile; a value of merchandise in the shopping cart; a type of merchandise in the shopping cart; or a mode of communication.

In some embodiments, the secondary notification may include at least one of: a pop-up notification; a notification on a lock screen of a mobile device; a sound notification; a haptic notification; a color change in an inbox; movement or flashing of an icon or representation of the secondary notification on a display of a merchant device.

In some embodiments, the secondary notification may include information regarding why the secondary notification was surfaced.

In some embodiments, the secondary notification may include contextual information regarding a sender of the message.

In some embodiments, the secondary notification may include one or more suggestions for responding to the message.

In some embodiments, the generating the secondary notification may include stripping portions of the message.

In a further aspect a computing device for generating secondary notifications may be provided. The computing device may include a processor; and a communications subsystem, where the computing device may be configured to receive a message and generate a primary notification of the message. The computing device may further be configured to update a priority associated with the message and determine that the updated priority exceeds a threshold. The computing device may further be configured to, responsive to the determination that the updated priority exceeds a threshold, generate a secondary notification, the secondary notification being distinct from the primary notification.

In some embodiments the message may relate to at least one user accessing an e-commerce store, and wherein the priority may be updated based on the at least one user currently having an online session with the e-commerce store and having one or more items in a shopping cart associated with the online session.

In some embodiments the computing device may further be configured to: receive one or more further messages at the computing device; and update the priority associated with the message based on at least some of the one or more further messages.

In some embodiments the computing device may be configured to update the priority associated with the message by: analyzing the message to determine that the message relates to a pending or intended transaction rather than a completed transaction; and responsive to the determination that the message is related to a pending or intended transaction rather than a completed transaction, assigning a higher priority to the message.

In some embodiments, the computing device may be configured to update the priority associated with the message by: analyzing the message to determine that a response to the message will take less than a threshold time period; and responsive to the determination that the message will take less than a threshold, assigning a higher priority to the message.

In some embodiments, the computing device may be configured to update the priority based on at least one of: a customer profile; a value of merchandise in the shopping cart; a type of merchandise in the shopping cart; or a mode of communication.

In some embodiments, the secondary notification may include at least one of: a pop-up notification; a notification on a lock screen of a mobile device; a sound notification; a haptic notification; a color change in an inbox; movement or flashing of an icon or representation of the secondary notification on a display of a merchant device.

In some embodiments the secondary notification may include information regarding why the secondary notification was surfaced.

In a further aspect, a non-transitory computer readable medium for storing instruction code for generating secondary notifications may be provided. The instruction code, when executed by a processor of a computing device, may cause the computing device to receive a message and generate a primary notification of the message. The instruction code, when executed by a processor of the computing device, may further cause the computing device to update a priority associated with the message and determine that the updated priority exceeds a threshold. The instruction code, when executed by a processor of the computing device, may further cause the computing device to, responsive to the determination that the updated priority exceeds a threshold, generate a secondary notification, the secondary notification being distinct from the primary notification.

### BRIEF DESCRIPTION OF THE DRAWINGS

The present disclosure will be better understood with reference to the drawings, in which:

FIG. 1 is a block diagram showing an example e-commerce system capable of implementing the embodiments of the present disclosure.

FIG. 2 is a block diagram showing an example interface for a merchant using the e-commerce platform of FIG. 1.

FIG. 3 is a process diagram showing a process for surfacing secondary notifications when a priority level exceeds a threshold.

FIG. 4 is a dataflow diagram showing the processing of a message on a client device.

FIG. 5 is a dataflow diagram showing the processing of a message at least in part on a network server or element.

FIG. 6 is a block diagram showing an example secondary notification.

FIG. 7 is a block diagram showing an example secondary notification on a lock screen of a mobile device.

FIG. 8 is a block diagram showing a simplified computing device capable of being used with the embodiments of the present disclosure.

### DETAILED DESCRIPTION

The present disclosure will now be described in detail by describing various illustrative, non-limiting embodiments thereof with reference to the accompanying drawings. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with the embodiments of the present disclosure, messaging applications are provided which provide smart message management. In some embodiments, this is done utilizing signals to a user that a particular message should be given a higher priority. Such signals may include a secondary notification regarding the message to a user of a computing device. Further, in some embodiments the secondary notification may include further signals embedded therein to flag the message to a user.

In one embodiment, the user may be a merchant operating an electronic storefront. A merchant can be overwhelmed by messages relating to an online store, where not every message calls for urgent action, but a message from a prospective customer might warrant urgent action. A correlation may exist between the timely response to messages by a merchant and the conversion of sales. For example, the message could be a yes/no question relating to a product already in the customer’s cart. A timely answer could lead to the customer making a purchase. Therefore, in this embodiment, a messaging application could prioritize this customer’s message by providing signals to a merchant.

In other embodiments, the user of the messaging application does not need to be a merchant. Messages could be prioritized for a variety of reasons. For example, in some cases messages to utility workers in the field may be prioritized based on the safety of the system, worker, or other criteria, or based on the impact the instructions or information in a message may have to the overall system. In this case, the messaging application of the present disclosure could provide signals to such workers when a message is a higher priority. Other examples of uses of the present system are also possible. The example of a merchant is merely provided for illustration purposes in the present disclosure.

While a smart inbox can display messages in one or more sorted list(s), and may even have a system for prioritizing messages, a smart inbox alone cannot direct the user’s attention to messages requiring urgent action in a timely manner.

In this regard, a system is provided which sends secondary notifications to the user when a message priority reaches a certain threshold. The message may be analyzed, for example using language parsing, machine learning models, or other techniques, to find a message priority. Details about the message or sender of the message may further be used in this analysis. In a merchant example, the priority may be based on a benefit of responding to the customer, as determined by the message analysis model.

Various criteria could be used to make a determination of whether to send the secondary notification. For example, in the merchant case, criteria may include whether the customer is still online, whether there are items in a customer’s cart, whether the message is a pre-purchase request or a post-purchase request, a customer profile, a value of goods in a shopping cart, a type of goods in a shopping cart, a mode of communication, an estimated time to respond to a message, other messages from the customer, among other criteria.

Based on the signals or criteria, a priority may be assigned to a message. In some cases, the priority may be reflected as a value assigned to the message. A high value reflects a high likelihood that the customer is about to make a purchase, and/or a low cost to the merchant to respond to the customer.

In some cases, the value must meet a threshold in order for the secondary notification to be surfaced to the merchant. In some cases, the value may be used to rank messages and the messages may be surfaced in a particular order to the merchant. Other options are possible.

Therefore, a system is provided in which a merchant may receive a message. The message may be received over one channel in some cases. In other cases, the message may be received have over an aggregation of different channels. For example, the merchant may have a messaging application through an e-commerce platform that accepts messages from one or more of: Apple business chat, Instagram DM, proprietary messaging within the e-commerce platform, WhatsApp, SMS, MMS, email, among other options.

The system may then analyze the messages to determine messages that need an urgent response or that are easy to answer and place a value on the messages.

Based on the determination, a notification may be provided to the merchant. The notification may be a second notification different from the standard notification over the messaging channel. Examples of secondary notifications could include pop up messages, messages on a lock screen of a mobile device, messages within a toolbar on a computer or mobile device, messages that appear with a different colour, appear to be flashing, or messages that somehow exhibit motion on the screen of the computing device, audio or haptic feedback that distinguishes the message from other messages, among other options.

Each aspect is described in more detail below.

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

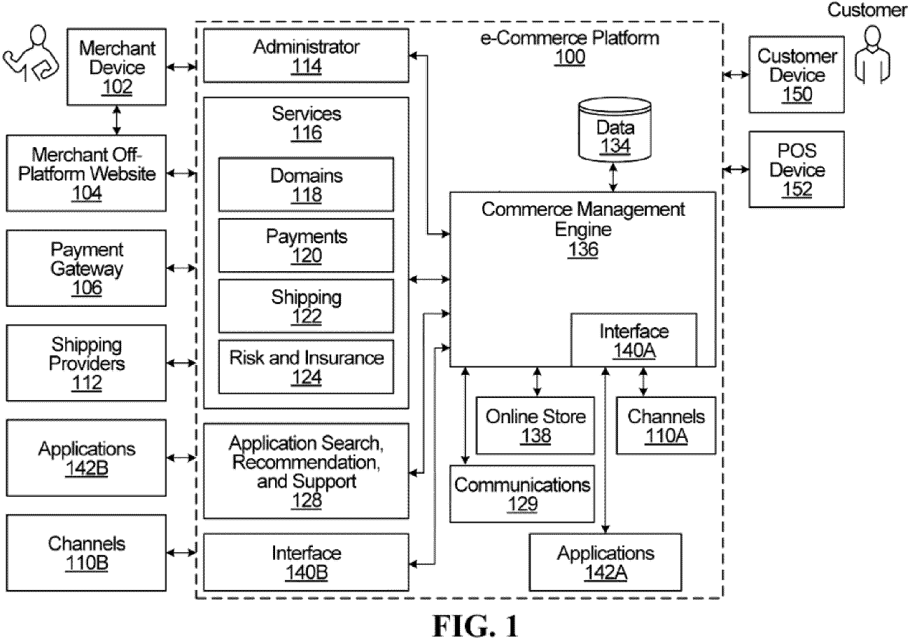

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant’s online e-commerce service offering through the e-commerce platform 100, where an online store 138 may refer either to a collection of storefronts supported by the e-commerce platform 100 (e.g., for one or a plurality of merchants) or to an individual merchant’s storefront (e.g., a merchant’s online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant’s storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc.. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (laaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store’s product information. It may be that themes can be further customized through a theme editor, a design interface that enables users to customize their website’s design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

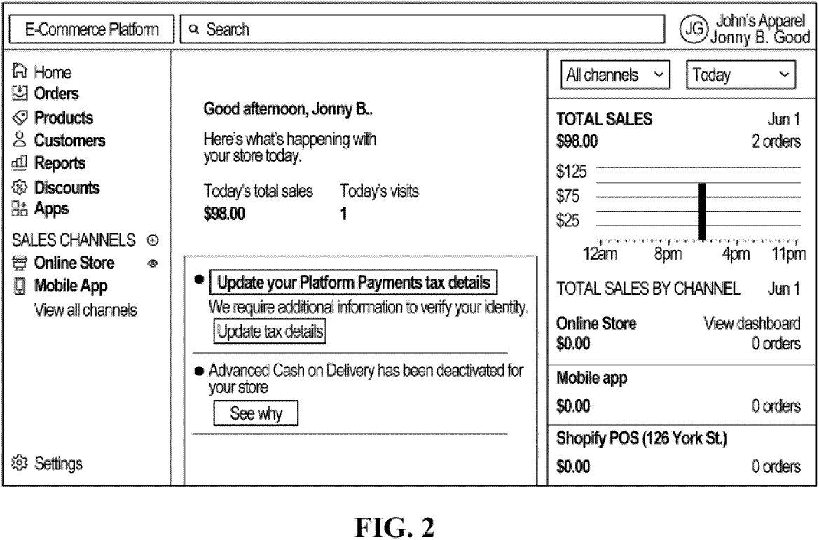

FIG. 2 depicts a non-limiting embodiment for a home page of an administrator 114. The administrator 114 may be referred to as an administrative console and/or an administrator console. The administrator 114 may show information about daily tasks, a store’s recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store’s 138 recent visit or order activity, updating the online store’s 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant’s business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant’s account; and settings applied to a merchant’s online store 138 and account. A merchant may use a search bar to find products, pages, or other information in their store.

More detailed information about commerce and visitors to a merchant’s online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store’s sales and engagement data. An activity feed in the home metrics section may be provided to illustrate an overview of the activity on the merchant’s account. For example, by clicking on a ‘view all recent activity’ dashboard button, the merchant may be able to see a longer feed of recent activity on their account. A home page may show notifications about the merchant’s online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant’s bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant’s online store 138, perform tasks through the administrator 114, implement new flows for a merchant through a user interface (e.g., that is surfaced through extensions / API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant’s products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant’s products through a number of different channels 110A-B such as, for example, the merchant’s online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer’s contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant’s use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren’t returned and remain in the customer’s hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Message Handling

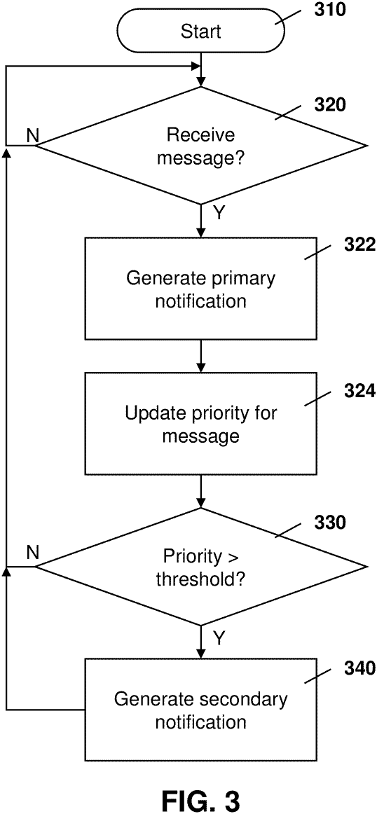

In accordance with the embodiments of the present disclosure, smart messaging applications are described which may surface certain messages to a user based on various criteria. Reference is now made to FIG. 3.

The embodiment of FIG. 3 may occur at one or more computing devices. As described in more detail below, the embodiment of FIG. 3 could occur at a computing device associated with an end user such as a merchant. In other cases, the embodiment of FIG. 3 could occur entirely on a server or plurality of servers, which then communicate with a user device. In other cases, the embodiment of FIG. 3 could occur on a combination of server(s) and the end user device.

The process of FIG. 3 starts at block 310 and proceeds to block 320 in which a check is made to see whether a message has been received. The message may be received over a variety of channels, and the check at block 320 could monitor one, or a plurality of channels, depending on the implementation. For example, the merchant may have a messaging application through an e-commerce platform that accepts messages from one or more of: a proprietary application, via an instant messaging application, a short message service (SMS) or multimedia messaging service (MMS) communication, an email, Apple™ business chat, Instagram™ Direct Messaging (DM), WhatsApp™, among others.

If, at block 320, it is determined that no message has been received, the process proceeds back to block 320 to continue to check for a message receipt. In some embodiments, this may be implemented using a trigger that could start the process when a message is received.

Once a message is received, as determined at block 320, the process proceeds to block 322 in which the system may generate a primary notification. This may be done, for example, by forwarding the message to an application that was expecting the message and then such application creating a standard notification. For example, if an email is received, the email may be placed into the inbox of the email application and a notification such as a vibration on a smart phone, an audio alert on any computing device, and/or a pop up in a notification bar may be provided to the user of the computing device, for example.

Similar visual, audio or haptic notifications may be provided for other messaging types or channels.

As provided above, the operator of a busy storefront may be inundated with messages and therefore such primary notification on receipt of a message may be insufficient to flag the message to such merchant. The merchant may simply ignore messages, deal with messages at a subsequent time, or respond too late to the message.

In this regard, the system proceeds from block 322 to block 324 in which the priority for the message may be updated. Specifically, if the message is the first message received from the client or the first message received as part of a single transaction, the updating at block 324 may create a new priority for the message. If the message is a subsequent message in a chain of messages, then the updating at block 324 may involve adjusting a previously found priority level for the message. The chain of messages could in some cases be based on communications in a single channel of communication. In some cases, the chain of messages could be part of a plurality of channels and could be consolidated at the computing device.

The priority of the message may be based on various factors, including the contents of the message itself and/or the context surrounding the message.

In one case, the priority may be based upon determining that a customer who sent the message is still online and has items in his or her digital shopping cart. This may be done, for example, by correlating the message that has been received with a user identity at the storefront. For example, a user may have logged in prior to adding items to a shopping cart, and thereafter, a message received from a source that is correlated to the user identity for the storefront could be an indication of whether such user has any items in his or her cart.

In other cases, the messaging platform itself may be a channel for purchasing items, and the shopping cart information for a user utilizing such messaging platform may be visible to the computing device that is updating the priority at block 324.

In other cases, contents of the message may be analyzed utilizing, for example, a neural network, natural language processing model or machine learning model and such contents may provide an indication that the customer is asking about an item in a shopping cart and a scan of the system for active shopping carts having that item could be used for the correlation.

Other options for the correlation are possible.

Therefore, in some cases, the priority level for the message may be related to whether the customer is still online and has items in his or her shopping cart.

In some cases, other or additional criteria could also be used to find or update a priority level.

For example, the criteria may include an analysis of the message received by the merchant to determine whether the message deals with a pre-purchase request rather than a post-purchase request. This may be done based on a machine learning module analyzing the contents of the message in some cases. A pre-purchase request may be considered to be a higher priority request as it may lead to a future sale.

In some cases, the criteria may include information about the customer. For example, a priority may be increased if the customer is a returning customer, a high value customer, based on the customer’s previous purchases, a location of the customer, among other such factors.

In some cases, the criteria may include information about the shopping cart, including the value of the goods in the shopping cart, the type of goods in the shopping cart, among other such factors. For example, certain types of goods may have a higher conversion rate and therefore be prioritized over other types of goods which have a lower conversion rate.

In some cases, the mode of communication may also be a factor. Certain modes of communication may indicate that a response is required more quickly. Therefore, an email message may have less urgency than a text message or live chat.

In other cases, the criteria may include an estimated time for responding to the request. Specifically, the message may be analyzed, for example through a machine learning module, to determine whether a response to the message will take a short or a long amount of time. This may be based on an estimated response time threshold that could be configured within the system. For example, if the message deals with something that would likely be in the merchant’s knowledge, the time to respond may be considered shorter than if the message response would require a merchant to open secondary records or databases to find an answer to a question.

Other possible criteria include: the contents of recent chat messages sent by the customer; a specific item having been in the customer’s cart when certain chat messages were sent by the customer; past purchases recently made by the customer (e.g. of products complementary to the specific item); how many Instagram or social media followers the customer has; and/or time on site, product pages viewed, among other criteria.

While the above criteria are directed to merchants, in other cases, criteria may be tailored to a non-merchant situation and the contents of the message or context surrounding the sender or message may similarly be used to find/update a priority level for the message.

In some cases, the criteria that could be used for finding/updating a priority level could be configurable by one or more parties. Specifically, in some cases a merchant may be capable of setting the criteria that would be important to such merchant in order to prioritize specific messages. In other cases, an e-commerce platform hosting the merchant could set the criteria for finding and updating a priority level. In other cases, other parties such as a service provider, employer, or other entity could set the criteria that could affect the priority level for the end user. In other cases, the criteria may be standardized and used for each participant in the system.

Therefore, based on the various criteria and the content and context of the message, a priority level could be set for the message.

In one case, the priority level could be a value assigned to the message and/or chain of messages. For example, each criterion could be assigned a priority value or weighting, and the cumulative value could be provided for the message or chain of messages. Therefore, various criteria could be valued differently and assigned a different weight in some embodiments.

For example, in some cases the value may reflect the likelihood that a customer is about to make a purchase and/or that there is a low cost to the merchant to respond to the customer.

In other cases, the value may reflect an urgency to respond to a client or the sender of the message.

The system may also derive a number of intermediate values from which the value of responding to the customer is ultimately derived. For example, the system may use machine learning to assign topics to chat messages sent by the customer to the merchant. The system may then, from the assigned topics, score the customer in relation to one or more specific intents. From these scores, the system can then derive a value of responding to the customer, with a view to capturing “high intent customers”.

In some cases, criteria may be further used to lower a priority level. Specifically, the criteria may indicate that the message may not need to be responded to quickly and therefore the value for the priority level may be reduced. For example, if a location of the customer sending the message is outside of the jurisdiction serviced by the electronic storefront then the priority level may be decreased in some cases. In other cases, other factors both within the text of the message and the context of the message could be used to reduce the priority level.

Based on the above, a priority level is assigned to the message at block 324.

The process then proceeds to block 330 to check whether the priority level exceeds the threshold. Specifically, in some cases, the priority level or value must meet a threshold in order for a secondary notification to be surfaced to the user. In some cases, the value may be used to rank messages and the messages may be surfaced in a particular order to the merchant. Other options are possible.

From block 330, if the priority level does not exceed the threshold, the process proceeds back to block 320 to wait for a new message.

Conversely, from block 330, if the priority level exceeds a threshold then the process proceeds to block 340 in which a secondary notification may be generated. Depending on whether the computing device is a server or the end user device, the generation of the secondary notification may simply be a message between a server and computing device to display a secondary notification. The computing device would then receive this message and based on settings at the device or at an application within the device, cause the secondary notification to be surfaced to the user.

If the computing device is the end user device, the generating at block 340 may allow for the surfacing of a secondary notification.

Specifically, the notification may be a second notification different from the standard notification over the messaging channel. Examples of secondary notifications could include pop up messages, messages on a lock screen of a mobile device, messages within a toolbar on a computer or mobile device, messages that appear with a different colour, appear to be flashing, or messages that somehow exhibit motion on the screen of the computing device, audio or haptic feedback that distinguishes the message from other messages, among other options.

The notification in some cases may be provided to certain staff or employees of the merchant. For example, an analysis of the text of the message may indicate that certain employees are in a better position to deal with the response. This may be based on the topic of the message in some cases. In some cases it may be based on past performance by the staff member or employee in the conversion of certain message types to sales. Other examples are possible.

In some cases, the notification may include information about why the message was surfaced. Specifically, a note to the merchant may be added to the notification indicating that the message response may have a high probability of resulting in a sale, that the message will take a short time to answer, that the message is a pre-purchase message, or similar information.

In some cases, the notification may include past contextual data to the merchant about the particular customer that is sending the message. For example, the notification might link to a web page or open an application that displays past chat messages sent to and received from the customer; past emails sent to and received from the customer; past purchases by the customer; the number of followers that a customer has on a social media site; among other such information.

In some cases, the notification may include suggestions about what actions the merchant can take. For example, a database of standard answers may exist for standard questions and an analysis of the text of the message may prompt the merchant to use a particular answer. In some cases, the database of standard answers may be composed of answers that have received a higher conversion to sales in the past. Therefore, the standard answers may have been chosen and revised based on past success with such answers. In some cases, the merchant may compose answers that the merchant would like used for particular questions, and these could be stored in a repository or database.

In some cases, the notification may allow a merchant to insert a button or token into the response which would allow the customer to complete the sale immediately. For example, the notification may allow for a response about sizing, and insert a sentence “if this answers your question and you would like to purchase now, please click here.”

In some cases, the notification may allow other incentives to be added to the message. For example, a coupon or discount could be applied to the purchase in order to increase the chances of converting the sale.

In some cases, the notification may strip portions of the message to leave only the essential parts of the message within the notification, therefore allowing the merchant to quickly analyze and formulate a response to the message.

Notifications can in some cases be managed. In particular, if notifications are provided to the merchant, but the merchant does not respond to them immediately, the notifications may subsequently be filtered as the client goes offline, if the client has removed items from their cart, among other factors.

Similarly, if the merchant does not respond to the notification for a specific time period, the notification may be re-surfaced, potentially with information about how long the customer has been waiting.

Based on the notification, a response may be sent to the customer. In some cases, the response may be sent over the same channel that the message arrived from. In other cases, the response may be sent over other channels. If the notification included information for responding, part or all of the message may include the information from the notification.

In this way, a user of a computing device may be provided with an indication that a message has exceeded a priority level threshold and may therefore require more immediate attention.

From block 340 the process proceeds to block 320 in which further messages may be monitored.

### User Device Processing

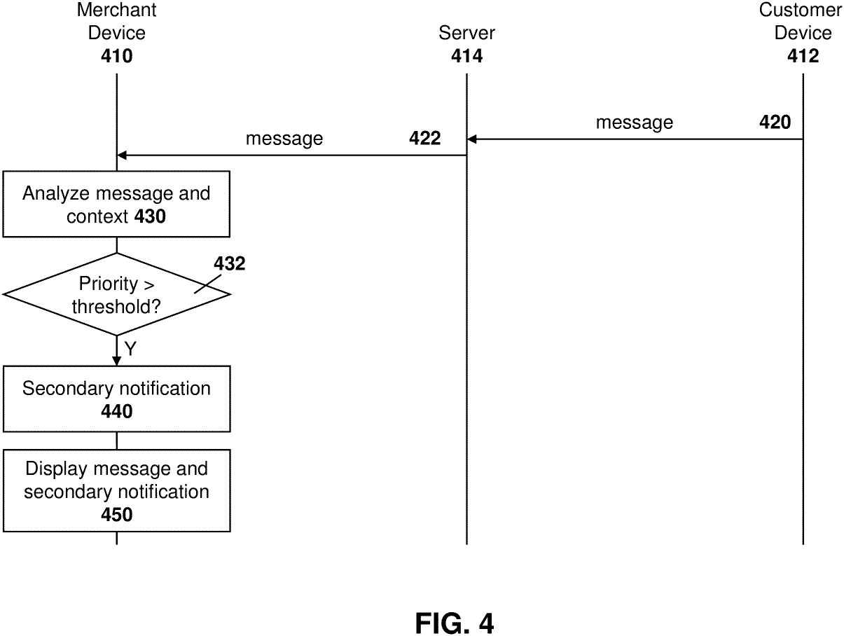

As indicated above, the process of FIG. 3 can be done at one or more server devices, the merchant device, or a combination of various computing devices. Reference is now made to FIG. 4.

The process of FIG. 4 provides the actions and processing occurring primarily on the merchant device 410. In particular, a customer device 412 may be used to generate messages and communicate with merchant device 410, utilizing a server 414. In particular, server 414 can represent the email infrastructure, ecommerce platform infrastructure, Internet infrastructure, messaging application infrastructure or the like. In this regard, server 414 could be comprised of multiple servers performing various actions.

A customer or other user on device 412 may compose a message 420, which then may be sent through server 414 to merchant device 410, as shown with message 422.

Merchant device 410 receives message 422 and may then analyze the message and context of the message at block 430. The actions at blocked 430 are similar to those in block 324 of FIG. 3.

Based on the analysis at block 430, the merchant device may check whether the priority is greater than a threshold at block 432 and if yes, may generate a secondary notification at block 440.

The merchant device 410 may then display the message and secondary notification, if needed, at block 450.

The displaying of the primary notification may occur by placing the message within an inbox or application, and then receiving the auditory, haptic or visual feedback typically associated with such primary message, if any.

The displaying of the secondary notification may include various visual, auditory or haptic feedback to the merchant to alert the merchant that a message with a priority exceeding a threshold has been received and should be acted on. Such secondary notification would differ from the primary notification for such message.

### Server Processing

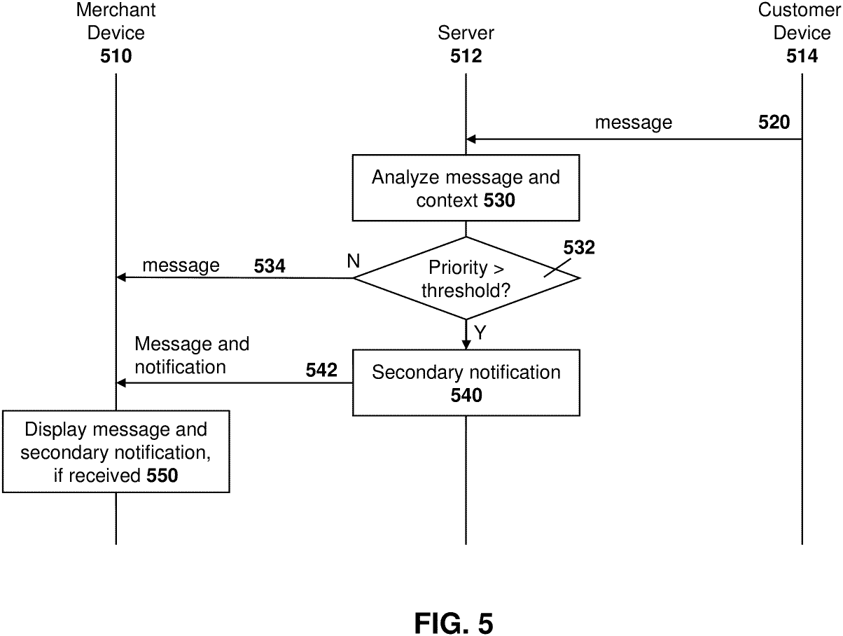

In a further embodiment, some of the processing may be done on one or more network servers. Reference is now made to FIG. 5.

In particular, in the embodiment of FIG. 5, a merchant device 510 could be any device associated with a merchant or end user. A server 512 could be one or more network servers that are configured to act within a messaging infrastructure. A device 514 could be a customer device or other user device.

In the embodiment of FIG. 5, a customer or user may use device 514 to send message 520 to server 512.

Server 512 may receive message 520 and analyze the message and its context at block 530. The processing at block 530 is similar to the processing performed at block 324 from the embodiment of FIG. 3.

If, based on the processing at block 530, the priority level of the message does not exceed a threshold, as determined at block 532, then a message 534 may be sent to merchant device 510. Message 534 could simply be message 520 that is being forwarded to an application on merchant device 510.

Conversely, if the server 512 determines that the priority level for the message exceeds a threshold at block 532, then the server may proceed to block 540 in which a secondary notification may be generated. Such secondary notification in this case may simply be a signal to the merchant device 510 that the message has a priority level that exceeds a threshold and that the merchant device 510 should surface the message with a secondary notification. Therefore, block 540 may simply be the generation of a signal to the merchant device 510 rather than the creation of the secondary message itself in some cases.

The message and notification may be sent to the merchant device 510 as shown with message 542.

The merchant device 510 may then display the message with a primary notification as would typically be done on the merchant device. Further, the merchant device may, in some cases, generate the secondary notification based on an indication in message 542 and surface such secondary notification to the user of merchant device 510.

In other cases, the notification within message 542 may include the complete secondary notification. In this case, merchant device 510 may just display the secondary notification that was received within message 542.

Therefore, the embodiments of FIGS. 4 and 5 show that the processing of messages, determination of the priority level of the message and the creation of the secondary notification can be done by various entities.

### Example Pop-Up Secondary Notification

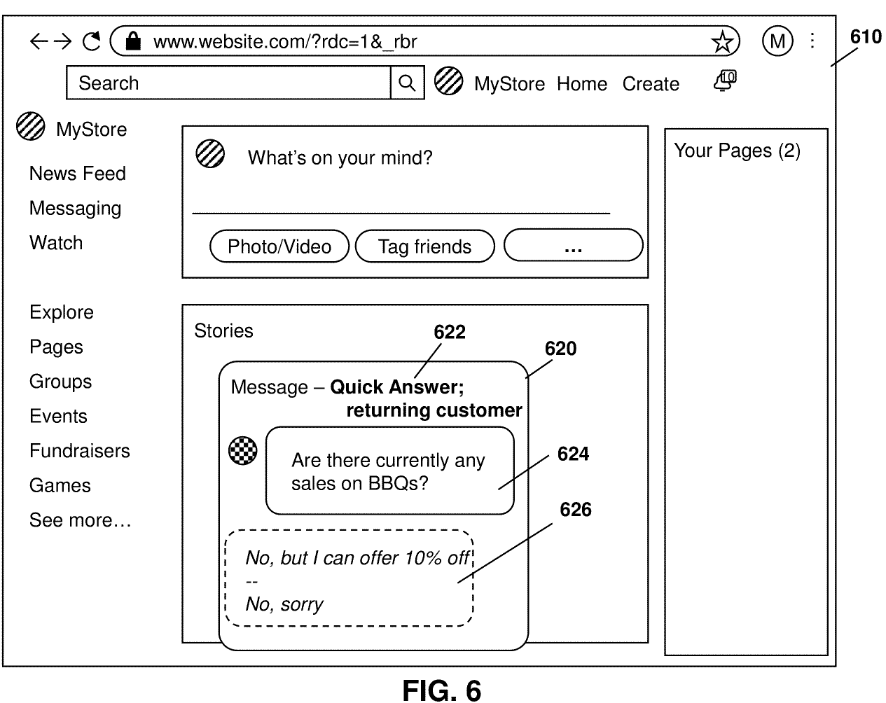

Reference is now made to FIG. 6. In an example use of the smart mail notification system of the present disclosure, a merchant may utilize a messaging application 610 on a computing device belonging to the merchant.

In this case, a customer may send a message asking whether there are currently any barbecues on sale. In accordance with the embodiments of the present disclosure, the system analyzes the message, either at the merchant’s computing device or at a network server, and determines that the message has a priority level that exceeds a threshold. In particular, it may be determined that the message requires little time to answer, that the customer is a returning customer, and the customer is currently online. Based on this determination, a secondary notification may be surfaced to the merchant on the merchant device.

Specifically, the message may be placed into an inbox, message tray, notification window or other location for the primary notification. However, a pop up 620 may also be displayed to the merchant, where pop up 620 is a different form of notification than typically presented to the merchant.

In this case, the pop up 620 may include information 622 on why the message was surfaced. In the example of FIG. 6, such information includes that the message would be quick to answer and that the customer is a returning customer. Such information may be beneficial to allow the merchant to respond to the customer. In some cases, the message that the customer is a returning customer may be a link which could open a new window providing context about such customer, including past messaging and conversations, past purchases, and/or other information related to the customer. However, in some embodiments, the added information 622 is optional and may not necessarily be placed in the secondary notification.

Further, the customer’s question or message may be placed within the secondary notification, as shown with box 624. In some cases, information from the message may be cut and only the portions that are deemed relevant, for example by a machine learning model, may be presented it to the merchant. Other ways to modify the secondary notification include stripping and stitching subsections of the whole message thread together to generate a shorter message that describes the buyer’s issue in a more concise way. In some cases, natural language processing (NLP) models can be used to generate the shorter message that will concisely summarize the issue. In some cases, all information in the original request or message from the customer may be provided in box 624.

In some cases, pop-up 620 may further include suggested answers shown at box 626. If the merchant wants to use a suggested answer, such suggested answer may simply be clicked and an answer for the customer may be sent. For example, in the embodiment of FIG. 6, the merchant is given an option of offering a 10% discount on a product. If the merchant clicks this link, then a response offering a 10% coupon or coupon code may be provided to the customer, for example.

However, suggested answers in box 626 are optional and may not be provided as part of the secondary notification in some cases.

Pop up 620 is shown to be placed over the application 610. However, in other cases, the pop up may open even if application 610 is not open. Further, in other cases, rather than a pop up, the secondary notification may be provided in a notification tray on the desktop of the user, on a mobile device notification screen, accompanied by audio and or haptic feedback, among other options.

If the messaging application would typically provide a pop up, then the pop up 620 could be differentiated, for example by having a different colour for the text in the popup window, a different outline for the popup window, or some other differentiating factor which would allow the merchant to quickly determine that the message should be responded to on a priority basis.

Similarly, if the message is an email, the email may be provided in the inbox of the user. A secondary notification may include changing the colour, causing the message to flash, among other options, instead of a pop up or a notification in the notification tray.

Other options for secondary notifications are possible.

### Lock Screen Example

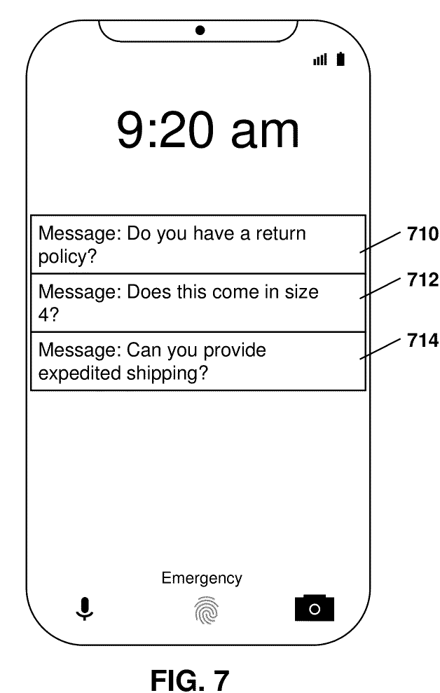

Further, in some embodiments, the notifications may be placed on a lock screen of a mobile device. Reference is now made to FIG. 7.

In the example of FIG. 7, a mobile device having a lock screen is shown. In this case, the merchant may have disabled notifications except for secondary notifications on the lock screen. Specifically, in some cases a mobile device may display various notification from messaging and other applications. In some cases, such regular notification may be disabled on the lock screen to allow for secondary notifications to be more prominent. However, this is optional, and in some cases the secondary notification can be distinguished in other ways, such as by changing their color, by flashing, among other options. Therefore, notifications 710, 712 and 714 have been deemed to be of a priority level that meets a threshold and thus warrants a secondary notification.

Further, notification 710, 712 and 714 may be sorted, for example based on priority, order received, among other options.

Utilizing the lock screen, the merchant would therefore be quickly able to determine what needs to be done to respond to potential clients.

The examples of FIGS. 6 and 7 are only provided for illustration of the embodiments of the present disclosure, and other forms of secondary notifications are possible.

### Computing Device

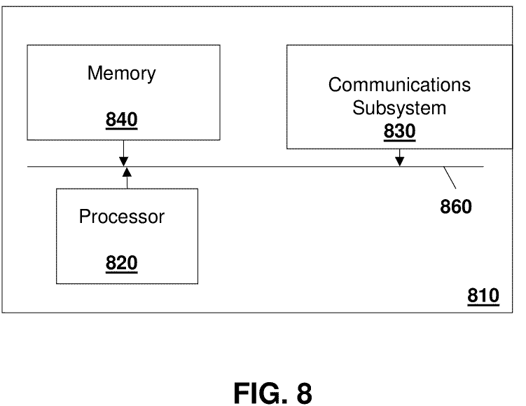

The above-discussed methods are computer-implemented methods and require a computer for their implementation/use. Such computer system could be implemented on any type of, or combination of, network elements or computing devices. For example, one simplified computing device that may perform all or parts the embodiments described herein is provided with regard to FIG. 8.

In FIG. 8, computing device 810 includes a processor 820 and a communications subsystem 830, where the processor 820 and communications subsystem 830 cooperate to perform the methods of the embodiments described herein.

The processor 820 is configured to execute programmable logic, which may be stored, along with data, on the computing device 810, and is shown in the example of FIG. 8 as memory 840. The memory 840 can be any tangible, non-transitory computer readable storage medium, such as DRAM, Flash, optical (e.g., CD, DVD, etc.), magnetic (e.g., tape), flash drive, hard drive, or other memory known in the art. In one embodiment, processor 820 may also be implemented entirely in hardware and not require any stored program to execute logic functions. Memory 840 can store instruction code, which, when executed by processor 820 cause the computing device 810 to perform the embodiments of the present disclosure.

Alternatively, or in addition to the memory 840, the computing device 810 may access data or programmable logic from an external storage medium, for example through the communications subsystem 830.

The communications subsystem 830 allows the computing device 810 to communicate with other devices or network elements. In some embodiments, communications subsystem 830 includes receivers or transceivers, including, but not limited to, ethernet, fiber, Universal Serial Bus (USB), cellular radio transceiver, a Wi-Fi transceiver, a Bluetooth transceiver, a Bluetooth low energy transceiver, a GPS receiver, a satellite transceiver, an IrDA transceiver, among others. As will be appreciated by those in the art, the design of the communications subsystem 830 will depend on the type of communications that the transaction device is expected to participate in.

Communications between the various elements of the computing device 810 may be through an internal bus 860 in one embodiment. However, other forms of communication are possible.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method for generating secondary notifications, the method comprising:
receiving a message;
generating a primary notification of the message;
updating a priority associated with the message;
determining that the updated priority exceeds a threshold; and
responsive to determining that the updated priority exceeds a threshold, generating a secondary notification, the secondary notification being distinct from the primary notification.

2. The method of claim 1, wherein the message relates to at least one user accessing an e-commerce store, and wherein the priority is updated based on the at least one user currently having an online session with the e-commerce store and having one or more items in a shopping cart associated with the online session.

3. The method of claim 1, further comprising:
receiving one or more further messages at the computing device; and
updating the priority associated with the message based on at least some of the one or more further messages.

4. The method of claim 1, wherein the updating the priority associated with the message includes:
analyzing the message to determine that the message relates to a pending or intended transaction rather than a completed transaction; and
responsive to the determination that the message is related to a pending or intended transaction rather than a completed transaction, assigning a higher priority to the message.

5. The method of claim 1, wherein the updating the priority associated with the message includes:
analyzing the message to determine that a response to the message will take less than a threshold time period; and
responsive to the determination that the message will take less than a threshold, assigning a higher priority to the message.

6. The method of claim 1, wherein the updating the priority is based on at least one of: a customer profile; a value of merchandise in the shopping cart; a type of merchandise in the shopping cart; or a mode of communication.

7. The method of claim 1, wherein the secondary notification comprises at least one of: a pop-up notification; a notification on a lock screen of a mobile device; a sound notification; a haptic notification; a color change in an inbox; movement or flashing of an icon or representation of the secondary notification on a display of a merchant device.

8. The method of claim 1, wherein the secondary notification includes information regarding why the secondary notification was surfaced.

9. The method of claim 1, wherein the secondary notification includes contextual information regarding a sender of the message.

10. The method of claim 1, wherein the secondary notification includes one or more suggestions for responding to the message.

11. The method of claim 1, wherein generating the secondary notification comprises stripping portions of the message.

12. A computing device for generating secondary notifications, the computing device comprising:
a processor; and
a communications subsystem,
wherein the computing device is configured to:
receive a message;
generate a primary notification of the message;
update a priority associated with the message;
determine that the updated priority exceeds a threshold; and
responsive to the determination that the updated priority exceeds a threshold, generate a secondary notification, the secondary notification being distinct from the primary notification.

13. The computing device of claim 12, wherein the message relates to at least one user accessing an e-commerce store, and wherein the priority is updated based on the at least one user currently having an online session with the e-commerce store and having one or more items in a shopping cart associated with the online session.

14. The computing device of claim 12, wherein the computing device is further configured to:
receive one or more further messages at the computing device; and
update the priority associated with the message based on at least some of the one or more further messages.

15. The computing device of claim 12, wherein the computing device is configured to update the priority associated with the message by:
analyzing the message to determine that the message relates to a pending or intended transaction rather than a completed transaction; and
responsive to the determination that the message is related to a pending or intended transaction rather than a completed transaction, assigning a higher priority to the message.

16. The computing device of claim 12, wherein the computing device is configured to update the priority associated with the message by:
analyzing the message to determine that a response to the message will take less than a threshold time period; and
responsive to the determination that the message will take less than a threshold, assigning a higher priority to the message.

17. The computing device of claim 12, wherein the computing device is configured to update the priority based on at least one of: a customer profile; a value of merchandise in the shopping cart; a type of merchandise in the shopping cart; or a mode of communication.

18. The computing device of claim 12, wherein the secondary notification comprises at least one of: a pop-up notification; a notification on a lock screen of a mobile device; a sound notification; a haptic notification; a color change in an inbox; movement or flashing of an icon or representation of the secondary notification on a display of a merchant device.

19. The computing device of claim 12, wherein the secondary notification includes information regarding why the secondary notification was surfaced.

20. A non-transitory computer readable medium for storing instruction code for generating secondary notifications, which, when executed by a processor of a computing device, cause the computing device to:
receive a message;
generate a primary notification of the message;
update a priority associated with the message;
determine that the updated priority exceeds a threshold; and
responsive to the determination that the updated priority exceeds a threshold, generate a secondary notification, the secondary notification being distinct from the primary notification.
